(19) United States
(12) Patent Application Publication
(10) Pub. No.: US 2026/0241489 A1
(43) Pub. Date: Aug. 20, 2026

(54) METHOD FOR CREATING A WELD SEAM ON A WORKPIECE AND MACHINING DEVICE

(71) Applicant: Lessmüller Lasertechnik GmbH, München (DE)

(72) Inventors: Christian Truckenbrodt, Stockdorf (DE); Eckhard Lessmüller, München (DE); Bastian Hauptstein, Esslingen (DE); Samuel Adolph, München (DE)

(73) Assignee: Lessmüller Lasertechnik GmbH, München (DE)

(21) Appl. No.: 19/463,501

(22) Filed: Jan. 29, 2026

(30) Foreign Application Priority Data
Feb. 18, 2025 (DE) 10-2025106064.9

(51) Int. Cl. B23K 26/24; B23K 26/082

(52) U.S. Cl. CPC B23K 26/24; B23K 26/082

(57) ABSTRACT

The invention relates to a method for creating a weld seam on a workpiece by means of a high-energy machining beam, which comprises the following steps: creating the weld seam on the workpiece by means of the machining beam; scanning the weld seam by means of a sample beam; determining at least one remachining location at which a welding penetration depth is below a target penetration depth and/or at which a pore size, a target pore size and/or a porosity exceeds a target porosity; reworking the weld seam at least at one remachining location by means of the machining beam. The invention further comprises a machining device.

### CROSS-REFERENCE TO RELATED APPLICATIONS

The present application claims priority from German Patent Application No. 10 2025 106 064.9, filed February 18, 2025, the entire disclosure of which is incorporated herein by reference.

### TEHNICAL FIELD

The invention relates to a method for creating a weld seam on a workpiece with a high-energy machining beam and a machining device.

### BACKGROUND

Known methods for creating a weld seam on the workpiece have a welding penetration depth control. The welding penetration depth control specifies a nominal power of the machining beam depending on a current and a desired welding penetration depth. The measured welding penetration depth is ascertained by measuring points, in particular OCT measuring points.

To ensure sufficient quality of the weld seam, a calculation step of the welding penetration depth control has to be carried out with sufficient speed. Only then is it possible to adjust the performance of the machining beam with sufficient speed, so that the locations of the weld seam at which the measured welding penetration depth does not correspond to the desired welding penetration depth are minimized as much as possible.

To achieve this, the welding penetration depth control has to be carried out on a high-performance calculation unit. Due to their size, the calculation units cannot be integrated into the machining device. In addition, the input and output data of the welding penetration depth control have to be transmitted between the machining device and the calculation device in a technically complicated way.

Even if the calculation unit uses high-performance and thus expensive graphics boards to achieve welding penetration depth control as quickly as possible, a sufficient amount of measuring points (approx. 300) has to be established first to calculate the nominal power of the machining beam to ascertain the current welding penetration depth. This leads to a time delay between adapting the nominal power of the machining beam and creating the weld seam with the machining beam on the workpiece and thus to an insufficient quality of the weld seam or to a slow machining speed of the machining device.

Based on the prior art, the invention is based on the object of achieving improved creation of a weld seam on a workpiece.

According to the invention, this object is achieved with a method and a machining device as defined in the independent or ancillary claims and as described herein. Further embodiments can be found in the dependent claims.

### DESCRIPTION OF THE INVENTION

Described herein is a method for creating a weld seam on a workpiece with a high-energy machining beam according to the invention. The method comprises the following steps: Creating a weld seam on a workpiece by using a machining beam; scanning the weld seam by using a sample beam of an optical coherence tomograph; determining at least one remachining location at which a welding penetration depth is below a target welding penetration depth and/or at which a pore size, a target pore size and/or a porosity exceeds a target porosity; and reworking the weld seam on at least one remachining location, in particular on at least one of the remachining locations determined by using the machining beam.

By using the method according to the invention, a high degree of quality can be achieved. Even if the equipment for ascertaining an inline welding penetration depth is available, by subsequently ascertaining locations that need remachining and the targeted remachining of those, a welding result that might not be achieved by ascertaining online welding penetration depth alone can be achieved. In particular the fact that if the online welding penetration depth is ascertained, future readings are not available yet, which, however, might affect a quality of ascertaining, can be attributed for. However, the temporal division of welding and recognizing the welding penetration depth makes it possible to also take those readings into account and consider them for notifications and fits, for example. In addition, excessive control, particularly during setting times of the welding penetration depth, can be prevented by this.

In principle, a computing-intensive welding penetration depth control would also not be necessary. Thus, it would not be necessary anymore to use expensive calculation units, which potentially have to comprise expensive graphics boards. In addition, the data for calculating the welding penetration depth control does not have to be transmitted from the machining device to the calculation unit and from the calculation unit to the machining device in real time anymore. A complex and calculation-intensive online calculation of the welding penetration depth control is thus not absolutely necessary anymore.

By using the method according to the invention, it is rather possible to determine the remachining location directly and/or offline on an evaluation unit, which can be integrated into the machining device. As a result, the production costs incurred when creating the weld seams may be lowered significantly at sufficient and/or consistent quality of the weld seams.

The workpiece may comprise at least two components that are to be welded with each other. The weld seam may connect the components of the workpiece with each other.

The high-energy machining beam may be a laser beam. The laser beam may be pulsed and/or show a continuous performance. They are targeted on one or several workpieces to carry out machining processes, in particular laser beam welding. A processing zone, in which the material of the workpiece is melted, forms at the area of incidence of the high-energy machining beam on the workpiece. As a result, a so-called keyhole may be formed. It is located within the melt pool and is formed by a vapor cavity, which is created by the interaction of the machining beam with the workpiece. The machining beam may be created by a machining device. In particular, the machining beam may be created by a machining beam source. The machining device source may be disposed on the machining device and/or in the machining device and/or may be spaced from the machining device.

In particular, the sample beam for optical tomography measurements may be created by an optical coherence tomograph. In particular, the sample beam may be targeted at the workpiece to measure the weld seam. In particular the weld seam may be used to ascertain the welding penetration depth, the number of pores and/or the pore size of the weld seam and/or ascertain them at defined locations of the weld seam.

A well-tried set up provides coupling the sample beam into the machining beam and leads the sample beam and the machining beam essentially coaxial onto the workpiece via a joint optic. In this case, a sample device, in particular a sample scanner, may be used, for example in the form of an adjustable mirror arrangement with which the sample beam may be displaced in two spatial directions in a targeted manner.

For example, the sample scanner may have at least one and in particular two movable mirrors by means of which the sample beam may be displaced in a targeted manner. The sample scanner may be an acousto-optical modulator (AOM), through which the sample beam may be displaced. The sample device may be disposed in particular adjacent to a machining device. A machining scanner that makes the machining beam displaceable relative to the workpiece may be provided in the machining device. The machining scanner may allow a machining position on the workpiece to be displaced in at least one or two spatial directions. In some embodiments, the displacement may be alternatively or additionally realized by using a movement of a robot and/or linear axes. The machining device may be equipped with a fixed machining optic in particular, especially without a scanner, and the machining beam may only be displaceable by mechanical displacement, for example of a machining head.

For example, the machining scanner may have at least one and in particular two movable mirrors by means of which the machining beam can be displaced in a targeted manner. The machining scanner may be an acousto-optical modulator (AOM), through which the machining beam may be displaced in a targeted manner.

The sample beam may be in particular coupled into the machining scanner via the sample scanner and may be displaced into one or two spatial directions by using the sample scanner and the machining scanner on the workpiece. Moreover, the measuring device may comprise an optical coherence tomograph with which the measurements may be conducted in accordance with optical coherence tomography (OCT)

The welding penetration depth of the weld seam may be different at different locations of the weld seam. For example, the welding penetration depth may be different at different locations of the weld seam, since a composition of a keyhole, which has been created by the machining laser beam when creating the weld seam, may vary. In addition, the welding penetration depth may vary when applying different performances of the machining beam and when using different materials of the workpiece. For example, in the case of laser welding via the pulsed laser beam and/or continuous laser beam, the welding penetration depth may be measured. As soon as the machining laser beam enters the workpiece, the welding penetration depth may be measured with the sample beam. Similarly, the temporal/local length of the welding or the pulse may be measured or the number of welds / pulses may be counted.

Pores in the weld seam may be caused through the creation of gas bubbles that remain in the welding zone. Pores may occur on the inside as well as on the surface. The pore size may be defined by a pore diameter. The porosity may be defined by the number and/or size of the pores in the weld seam and/or in a portion of the weld seam.

The remachining location may be a location of the weld seam which does not fulfill the quality requirements of the weld seam. In particular, a remachining location may be defined on a location of the weld seam at which the welding penetration depth is below the target welding penetration depth. The target welding penetration depth may be a predetermined value for the whole weld seam and/or a value progression for the weld seam. Alternatively and/or additionally, the remachining location may be defined on a location of the weld seam at which the pore size exceeds the target pore size, for example according to DIN EN ISO 5817. In addition, the remachining location may be alternatively and/or additionally at a location of the weld seam at which the porosity exceeds the target porosity, for example according to DIN EN ISO 5817.

For effective machining, the reworking of the weld seam may be selectively, in particular exclusively, carried out at the remachining location and/or at the remachining locations.

The machining beam may be created in particular by a machining device and the sample beam may be created by a sample device, which are both parts of the machining device. For example, they may be disposed in the machining device and/or integrated into it. In addition, the remachining location may be determined in an evaluation apparatus, which is part of the machining device and/or integrated into it. Thus, the machining device may calculate the welding process directly offline.

The weld seam may be scanned while the weld seam is created. If the weld seam is scanned while the weld seam is created, the scan may be carried out behind and/or on the keyhole. As a result of this, direct insights into the keyhole and/or the newly created weld seam behind the keyhole may be gained. In addition, if the weld seam is scanned while the weld seam is created, a quicker machining of the workpiece is possible.

Alternatively and/or additionally, determining the remachining location may be carried out while the weld seam is scanned. Thus, this might save time when determining the remachining location. In addition, determining the remachining location may be alternatively and/or additionally carried out after the weld seam is scanned. In this case, all measuring points are already present upon determination of the remachining location. Thus, the remachining location may be ascertained more accurately.

Moreover, determining the remachining location may be based on a single measuring point, which is identified when the sample beam scans the weld seam. For example, a remachining location may be created at every measuring point at which the welding penetration depth is below a target welding penetration depth and/or at which the pore size and/or the porosity corresponding to a target pore size and/or exceeds a target porosity. As a result, a high quality of the weld seam is ensured. In this case, determining the remachining location may be based on a single measuring point.

In some embodiments, it may be provided that the welding penetration depth in the keyhole is measured during machining and that measurements to determine the pore size and/or porosity are carried out in addition after machining. Thus, information regarding the welding penetration depth as well as information regarding the porosity may be received in an efficient manner. In this case, the welding penetration depth is expediently measured during the welding process since measurements in the keyhole may be carried out during the welding process. Additional measurements might demand different sampling rates and/or may be difficult to carry out during welding in sufficient quality. An additional sample run as described may serve to receive further information, for example regarding porosity.

To compensate for potential measuring errors and/or measuring inaccuracies and/or to ensure that measuring errors and/or measuring inaccuracies are less severe when determining remachining locations, determining the remachining location may also be based on a plurality of measuring points, which are received during scanning of the weld seam by means of the sample beam. Determining the remachining location may for example be achieved by averaging the welding penetration depth, the pore size and/or the porosity, which has been determined based on a plurality of measuring points.

The method may further comprise at least one of the following steps: Ascertaining a property of the weld seam at the remachining location. Determining a context at the remachining location between a property of the weld seam at the remachining location, a desired property of the weld seam and a laser performance, with which the machining beam, by means of which the weld seam has been generated at the remachining location, has been created. Adapting the laser performance, in particular at the remachining location in accordance with the context. Determining the context at the remachining location and adapting the laser performance may in particular happen before reworking the weld seam at the at least one remachining location and/or after determining the at least one remachining location.

Thus, a more precise reworking of the remachining location is possible. In particular the desired property of the weld seam at the remachining location may be achieved when reworking the weld seam at least at one remachining location. The property of the remachining location may be a welding penetration depth, a number of pores and/or a pore size. The desired property of the weld seam may be a target welding penetration depth, a target number of pores and/or a target pore size of the weld seam and/or the target welding penetration depth, the number of pores and/or the target pore size in a certain section of the weld seam. The laser performance may be predetermined by an analog voltage, in particular a 0-to-10-volt signal. The analog voltage may be an input value of the machining apparatus and/or the machining beam source. The context might be a linear context. The adapted laser performance used for reworking the remachining location may be ascertained by multiplying a factor with the laser performance, with which the remachining location of the weld seam has been created. The factor might be ascertained by a division of the welding penetration depth at the remachining location by the target welding penetration depth of the weld seam

To be able to ensure a high quality of the weld seam with a simple method, the method may additionally comprise re-determining at least one remachining location at which a welding penetration depth is below a target welding penetration depth and/or at which a pore size, a target pore size and/or a porosity exceeds a target porosity. Re-determining the property of the remachining location may be carried out after reworking the weld seam at the remachining location. For example, the method step of determining a context at the remachining location between a property of the weld seam at the remachining location, a desired property of the weld seam and a laser performance, with which the machining beam, by means of which the weld seam has been generated at the remachining location, has been created, the method step of adjusting the laser performance according to the context as well as the method step of reworking the weld seam at the at least one remachining location may be carried out consecutively in an iterative manner until no more remachining locations may be determined in the method step of re-determining at least one remachining location. Thus, a sufficient quality of the weld seam may be ensured with low calculating capacity.

The method may further comprise at least one of the following steps. Creating a calibration weld seam by means of a machining beam. Ascertaining a characteristic of the calibration weld seam by means of a sample beam. Thus, creating the calibration weld seam and ascertaining the characteristic of the calibration weld seam are carried out before the weld seam is created. Due to the properties of the calibration weld seam, it is already possible to change settings of the machining device before creating the weld seam to optimize the creation of the weld seam. The orientation of the machining device may for example be adapted to the workpiece. Alternatively and/or additionally, settings of the sample apparatus, which creates the sample beam and/or of the machining apparatus, which creates the machining beam, may be changed as well. The property of the calibration weld seam may be a welding penetration depth, a number of pores and/or a pore size of the calibration weld seam.

In addition, the method may comprise at least one of the following steps. Determining a context of the calibration weld seam between the property of the calibration weld seam, a desired property of the weld seam and a laser performance, with which the machining beam, by means of which the calibration weld seam has been generated, has been created. Adapting the laser performance in accordance with the context of the calibration weld seam. As a result, die desired property of the weld seam may be achieved when creating the weld seam. In particular, determining the laser performance in accordance with the context on the basis of the calibration weld seam is carried out before the weld seam is created. The calibration weld seam may form a portion of the later created weld seam or it may show the entire course of the later created weld seam.

Thus, a more precise creation of the weld seam is possible. The desired property of the weld seam may be a target welding penetration depth, a target number of pores and/or a target pore size of the weld seam and/or the target welding penetration depth, the number of pores and/or the target pore size in a certain section and/or portion of the weld seam.

The laser performance may be predetermined by an analog voltage, in particular a 0-to-10-volt signal. The analog voltage may be an input value of the machining apparatus and/or the machining beam source.

The context might be a linear context. The adapted laser performance used to create the weld may be ascertained by multiplying a factor with the laser performance, with which the calibration weld seam has been created. By way of example, the factor may be ascertained by a division of the welding penetration depth of the calibration weld seam and/or in a certain area and/or portion of the calibration weld seam through the target welding penetration depth of the weld seam.

The invention further comprises a machining device, in particular a laser machining head for creating a weld seam on a workpiece by means of a machining beam, configured to carry out the method according to the invention. The machining device comprises a machining apparatus comprising a machining beam source configured to create the machining beam. The machining device further comprises a sample apparatus configured to scan the weld seam with a sample beam. The measuring device further comprises a focusing apparatus configured to project and/or to focus the machining beam and/or the sample beam onto the workpiece and an evaluation apparatus configured to determine at least a remachining location on the weld seam on the basis of scanning with the sample device.

The sample apparatus may be disposed adjacent to the machining apparatus and/or may be integrated into the housing together with the machining apparatus. A machining scanner that makes the machining beam displaceable relative to the workpiece may be provided in the machining apparatus. The machining scanner may allow a machining position on the workpiece to be displaced in at least one or two spatial directions. For example, the machining scanner may have at least one and in particular two movable mirrors by means of which the machining beam can be displaced in a targeted manner.

The sample apparatus may comprise a sample scanner. The sample beam may be in particular coupled into the machining scanner via the sample scanner and may be displaced into one or two spatial directions by using the sample scanner and the machining scanner on the workpiece.

Moreover, the measuring device may comprise an optical coherence tomograph with which the measurements may be conducted in accordance with optical coherence tomography (OCT).

The focusing apparatus may comprise a focusing lens, in particular a F-Theta lens.

The optical coherence tomograph may be configured to generate the sample beam and a reference beam. The optical coherence tomograph may further comprise a sample arm in which the sample beam is optically guidable and a reference arm in which the reference beam is optically guidable. The optical coherence tomograph may further comprise a sample unit configured to perform optical coherence tomography measurements by causing the sample beam and the reference beam to interfere to generate measurement data.

In particular, it is pointed out that all features and properties described with respect to devices as well as procedures can be applied mutatis mutandis to methods according to the invention and are applicable in the sense of the invention and deemed to be disclosed. The same applies vice versa. This means that structural features, i.e., features according to the device mentioned with respect to methods can also be taken into account, claimed as well as deemed to be disclosed within the scope of the device claims.

### BRIEF DESCRIPTION OF THE DRAWINGS

Subsequently, the present invention is described by way of example with reference to the attached figures. The drawing, the description and the claims contain numerous features in combination. The skilled person will expediently consider the features individually as well and use them sensibly in combination within the scope of the claims.

In the drawings:

FIG. 1 is a schematic representation of a machining device according to the invention;

FIG. 2 is a sequence diagram of an embodiment of the method according to the invention;

FIG. 3 is a sequence diagram of a further embodiment of the method according to the invention;

FIG. 4 is a sequence diagram of a further embodiment of the method according to the invention;

FIG. 5 is a sequence diagram of a further embodiment of the method according to the invention;

FIG. 6 is a sequence diagram of a further embodiment of the method according to the invention;

FIG. 7 is a welding penetration depth relating to a target welding penetration depth that has been generated by creating the weld seam;

FIG. 8 is a welding penetration depth relating to a target welding penetration depth that has been reworked by reworking the weld seam;

FIG. 9 is a welding penetration depth relating to a target welding penetration depth that has been generated by creating a calibration weld seam;

FIG. 10 is a welding penetration depth relating to a target welding penetration depth that has been generated by creating a calibration weld seam; and

FIG. 11 is a welding penetration depth relating to a target welding penetration depth that has been reworked by reworking the weld seam.

### DETAILED DESCRIPTION OF THE INVENTION

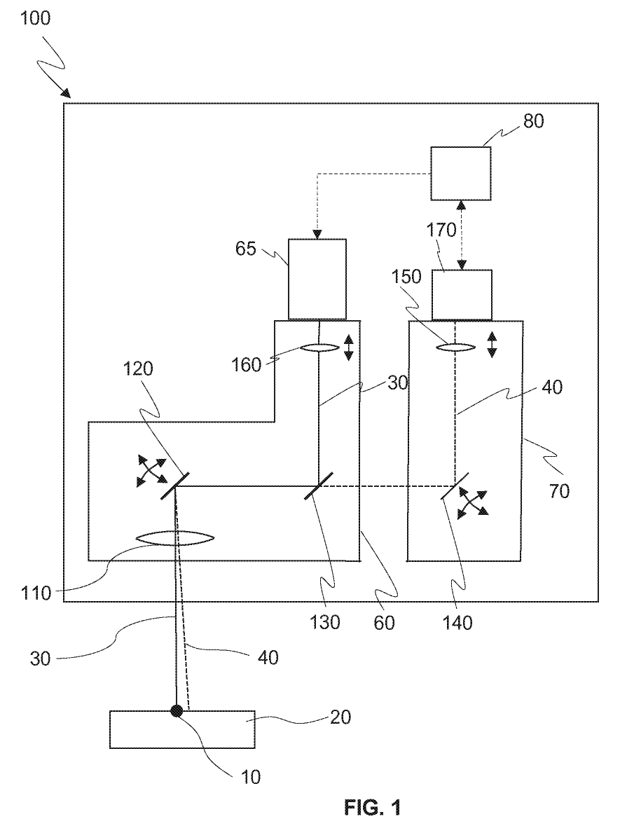

FIG. 1 shows a machining device 100 for creating a weld seam 10 on a workpiece 20 with a high-energy machining beam 30, a machining apparatus 60, a sample apparatus 70 and an evaluation apparatus 80.

The sample apparatus 70 shows an optical coherence tomograph 170 creating a sample beam 40 and receives measuring points 40 on the workpiece 20 by means of a sample beam, in particular on and/or in the weld seam 10. The course of the sample beam 40 may be predetermined in particular by the control device (not shown) and/or the evaluation apparatus 80. The sample beam 40 may be collimated by a sample beam collimation lens 150 and may be deflected in the direction of the machining apparatus 60 by a sample scanner 140. In particular the sample scanner 140 may be configured to displace the sample beam 40 in one and/or two spatial directions. For this purpose, the sample scanner 140 may comprise two moveable mirrors with which a respective displacement in one spatial direction may be achieved.

The machining apparatus 60 in particular comprises a machining scanner 120, a partially transparent mirror 130 to couple the sample beam 40 into the machining beam and a focusing lens 110. The machining scanner 120 may be configured to displace the machining beam 30 in one and/or two spatial directions. For this purpose, the machining scanner 120 may comprise two moveable mirrors with which a respective displacement in one spatial direction may be achieved. In the present case, the sample beam 40 may be coupled into the machining beam 30 so that the sample beam 40 may be displaceable by means of the machining scanner 120 as well. Thus, the sample beam 40 may be displaced by means of the sample scanner 140 and the machining scanner 120, whereas the machining beam 30 may be displaceable by means of the machining scanner 120. By using this arrangement, the sample beam 40 may be deflected relative to the machining beam 30.

For example, the sample beam 40 is coupled into the machining apparatus 60 through the partially transparent mirror 130 and subsequently deflected by the machining scanner 120. Subsequently, the sample beam 40 is directed onto the workpiece 20, for example through a focusing lens 110, in particular a F-Theta lens. The sample apparatus 70, in particular the coherence tomograph 170, may in particular be configured to scan the weld seam 10 on the workpiece 20 by adjusting the sample scanner 140 and/or the machining scanner 120.

The machining apparatus 60 may comprise a machining beam source 65 that creates the machining beam 30. In some embodiments, the machining beam 30 is colimated by a sample beam collimation lens 160. Subsequently, the machining beam 30 is directed and/or focused onto the workpiece 20, in particular through the partially transparent mirror 130, the machining scanner 120 and the focusing lens 110. In FIG. 1, the machining beam source 65 is only shown schematically. The machining beam source 65 may be disposed spatially separated from the components shown in FIG. 1. The machining beam 30 may be couplable into an optical input port of a machining head, which comprises the lenses and/or scanner mentioned. Similarly, the optical coherence tomograph 170 or at least its interferometer and/or a reference arm of the same may be located outside of the machining head. The sample beam 40 is then fed to the machining head, for example via a sample arm fiber. As such, it is to be understood that the arrangement of the components in FIG. 1 shall only visualize the functional principle.

The machining beam 30 is guided in particular along a machining trajectory onto the workpiece 20. In particular by adjusting the machining scanner 120, it may be ensured that the machining beam 30 follows the machining trajectory. Adjusting the first machining scanner 120 may be predetermined by the machining apparatus 60, in particular by the control device.

The evaluation apparatus 80 may adjust the laser performance with which the machining apparatus 60, in particular the machining beam source 65, generates the machining beam 30, on the basis of the measuring points of the coherence tomograph 170. In particular, the evaluation unit may send a 0-to–10-volt signal to the machining beam source 65 through which the laser performance, with which the machining apparatus 60, in particular the machining beam source 65, generates the machining beam 30, may be predetermined.

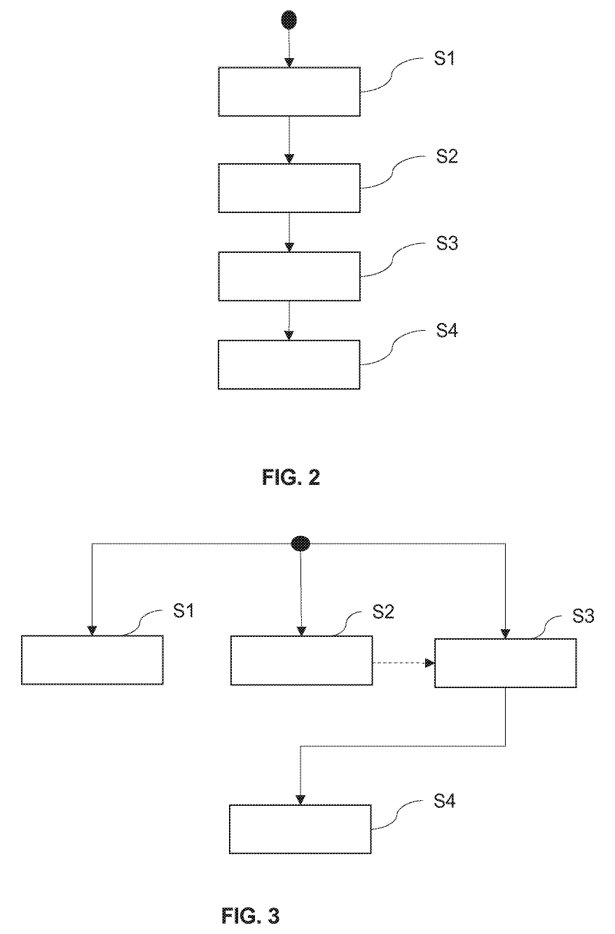

FIGS. 2 and 3 respectively show a sequence diagram with different embodiments of the method according to the invention for creating a weld seam on a workpiece with a high-energy machining beam. The method comprises step S1 “creating the weld seam”, in which a weld seam is created on the workpiece by means of a machining beam. The method further comprises step S2 “scanning the weld seam”, in which the weld seam is scanned by means of the sample beam. In step S2 “scanning the weld seam”, measuring points may be determined on the weld seam. The method further comprises step S3 “determining the remachining location”, in which a remachining location is ascertained on the basis of the measuring points at which the welding penetration depth is below a target welding penetration depth and/or at which a pore size exceeds a target pore size and/or the porosity exceeds a target porosity determined in step S2. In addition, the method comprises step S4 “reworking the weld seam at least at one remachining location”, in which the weld seam is reworked at least at one remachining location by means of the machining beam.

As shown in FIG. 2, steps S1 to S4 may be carried out sequentially one after the other. It is also possible that steps S1 to S3 are at least partly carried out parallel to each other, as shown in FIG. 3. The measuring points determined in step S2 may be continuously sent to step S3 for example. It is also possible that only steps S1 and S2 or steps S2 and S3 are carried out parallel to each other.

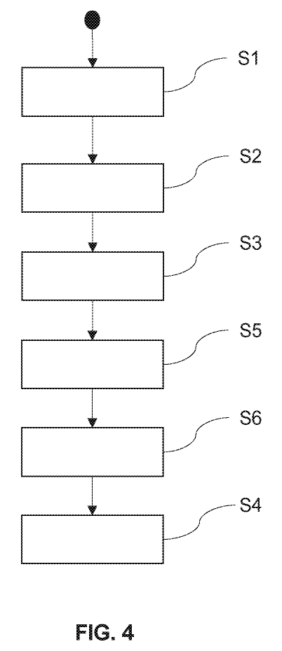

In other embodiments of the method according to the invention shown in FIGS. 4 to 8, steps S1 to S4 are shown sequentially one after the other. However, as shown in FIG. 3, at least steps S1 to S3 may be carried out parallel to each other. In these embodiments, which are shown in FIGS. 4 to 8, it is also possible that only steps S1 and S2 or steps S2 and S3 are carried out parallel to each other.

FIG. 4 shows a sequence diagram of a further embodiment of the method according to the invention. Compared to the embodiments shown in FIGS. 2 and 3, the embodiment shown in FIG. 4 additionally comprises a step S5 “determining a context at the remachining location” and a step S6 “adjusting the laser performance”.

In step S5, a context between a property of the weld seam at the remachining location, a desired property of the weld seam and a laser performance, with which the machining beam, by means of which the weld seam has been generated at the remachining location, has been created, is determined at the remachining location. The property may be a welding penetration depth, a pore size and/or a porosity of the weld seam and/or may be located in a defined portion and/or section of the weld seam. The desired property may be a target welding penetration depth, a target pore size and/or a target porosity of the weld seam and/or may be located in a defined portion and/or section of the weld seam.

In step S6, the laser performance is adjusted according to the context. For example, the laser performance is adjusted at the remachining location. The laser performance may be adapted at different remachining locations according to a different context.

Steps S5 and S6 thus may ensure a precise reworking of the weld seam at the remachining location. As shown in FIG. 4, steps S5, S6 and S4 may be carried out sequentially after each other and/or at least partly parallel to each other. For example, steps S6 and S4 may already be started after the context at the remachining location has been ascertained in step S5.

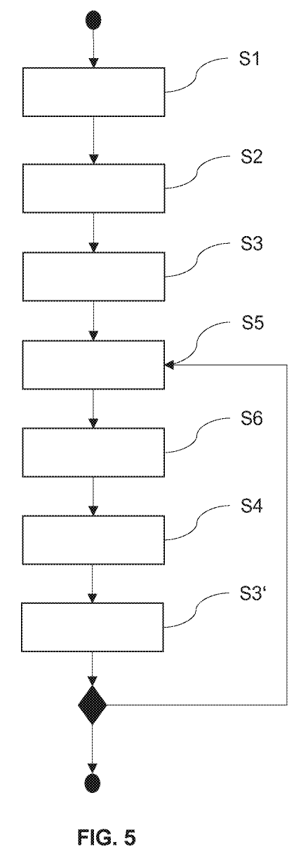

FIG. 5 shows a sequence diagram of a further embodiment of the method according to the invention. Compared to the embodiment shown in FIG. 4, the embodiment shown in FIG. 5 additionally comprises an additional step S3‘, which is carried out after step S4 to examine the quality of reworking. If at least one remachining location is determined in step S3‘, which is carried out again, steps S5, S6 and S4 may be carried out again. Otherwise, the method is terminated.

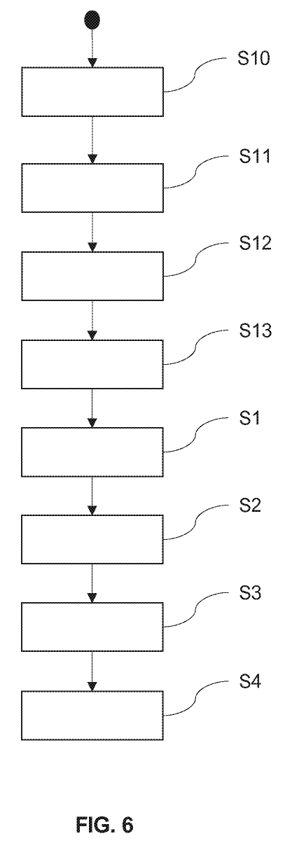

FIG. 6 shows a sequence diagram of a further embodiment of the method according to the invention. Compared to the embodiments shown in FIGS. 2 and 3, the embodiment shown in FIG. 4 additionally comprises step S10 “creating a calibration weld seam”, step S11 “ascertaining a property of the calibration weld seam”, step S12 “determining a context on the basis of a calibration weld seam” and step S13 “adjusting the laser performance according to the context on the basis of the calibration weld seam”.

In step S10, a calibration weld seam is created by means of a machining beam.

Subsequently, a property of the calibration weld seam is determined by means of a sample beam in step S11. The property may be a welding penetration depth, a pore size, a porosity and/or an orientation of the weld seam and/or may be located in a defined portion and/or section of the weld seam.

A context of the calibration weld seam is determined in step S12. The context is determined between the property of the calibration weld seam, a desired property of the weld seam and a laser performance, with which the machining beam, by means of which the calibration weld seam has been generated, has been created. The desired property may be a target welding penetration depth, a target pore size and/or a target porosity of the weld seam and/or may be located in a defined portion and/or section of the weld seam. In step S13, the laser performance is adjusted according to the context of the calibration weld seam. In the subsequent step S1, a weld seam which reduces the remachining locations may thus be created.

In the embodiment of the method shown in FIG. 6, steps S12 and S13 may be omitted. For example, the orientation of the machining device and/or the machining apparatus may be adapted regarding the workpiece on the basis of step S11 before step S1 is carried out. The embodiment of the method shown in FIG. 6, and thus at least one of steps S10 to S13, may be combined with each of the embodiments shown in FIGS. 3, 4 or 5.

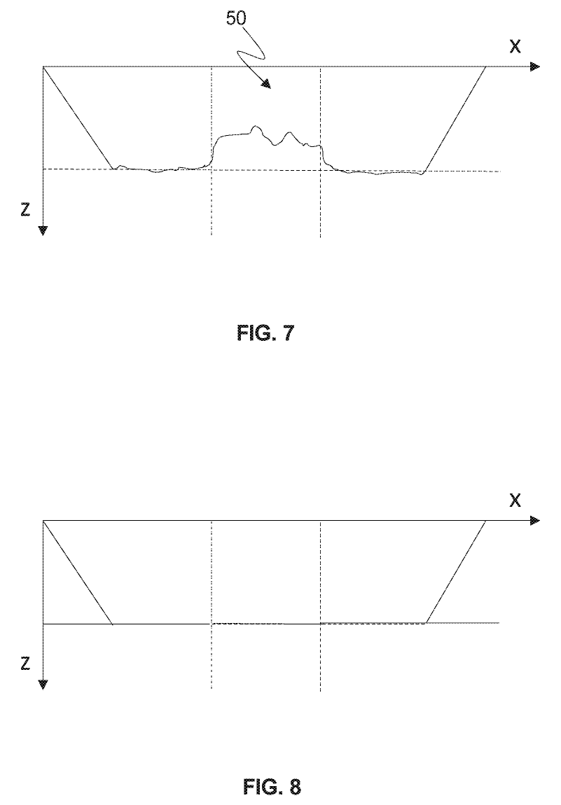

FIGS. 7 and 8 show a welding penetration depth after different method steps of an embodiment according to the invention of the method to create a weld seam. FIG. 7 shows a welding penetration depth (solid line) relating to a target welding penetration depth (dashed horizontal line) regarding an x-course of the workpiece. The welding penetration depth may be generated by creating a weld seam. As shown in FIG. 7, the target welding penetration depth could not be achieved across the whole x-course of the workpiece. FIG. 7 further shows a remachining location 50 (between two perpendicular, dashed lines) at which the welding penetration depth is below the target welding penetration depth.

FIG. 8 shows a welding penetration depth (solid line) relating to a target welding penetration depth (dashed horizontal line) regarding an x-course of the workpiece. The welding penetration depth may be created by reworking the weld seam at the remachining location. Preferably, the weld seam is selectively and in particular only reworked at the remachining location and the whole weld seam corresponds to the target welding penetration depth after reworking, as shown in FIG. 8.

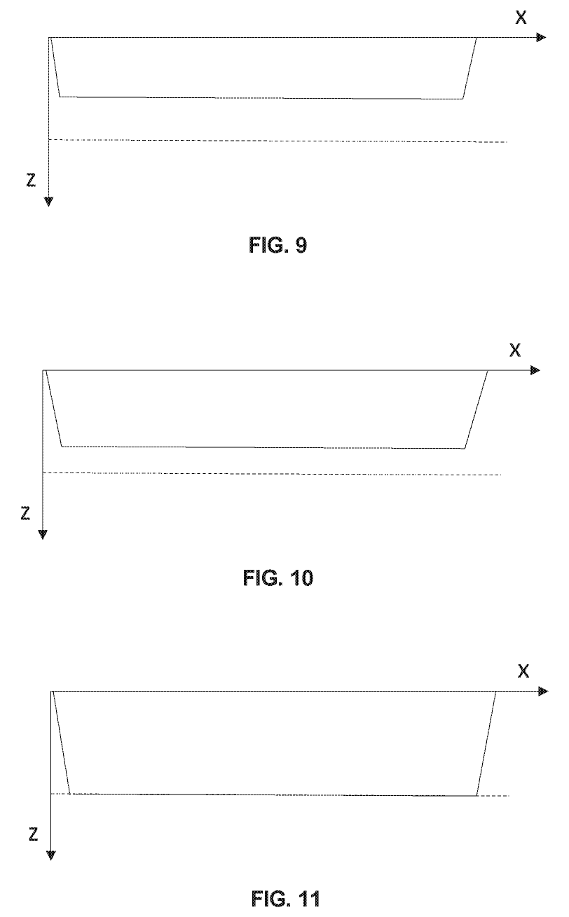

FIGS. 9, 10 and 11 show a welding penetration depth after different method steps of an embodiment according to the invention of the method to create a weld seam. FIG. 9 shows a welding penetration depth (solid line) relating to a target welding penetration depth (dashed horizontal line) regarding an x-course of the workpiece. The welding penetration depth may be generated by creating a calibration weld seam. As shown in FIG. 9, the target welding penetration depth could not be achieved once across the whole x-course of the workpiece. On the basis of the calibration weld seam and the context shown in FIG. 9, a laser performance may be adapted for creating a machining beam. FIG. 10 also shows a welding penetration depth (solid line) relating to a target welding penetration depth (dashed horizontal line) regarding an x-course of the workpiece. The welding penetration depth may be generated by creating a weld seam. As shown in FIG. 7, the target welding penetration depth could not be achieved across the x-course of the workpiece. This means that the whole x-course of the weld seam has to be reworked and thus forms the remachining location. FIG. 11 shows a welding penetration depth (solid line) relating to a target welding penetration depth (dashed horizontal line) regarding an x-course of the workpiece. The welding penetration depth may be created by reworking the weld seam at the remachining location. Preferably, the whole weld seam corresponds to the target welding penetration depth after reworking, as shown in FIG. 11.

In some embodiments, the process shown in FIGS. 9 to 11 may be chosen specifically to achieve a desired target welding penetration depth reliably, efficiently, with high quality, and in particular without accidental full penetration welding and/or welding too deep. To achieve this, an insufficient performance is actively chosen initially for the machining beam to create a profile. In general, welding penetration depths that are too deep may be actively chosen to validate the parameters chosen to achieve full penetration welding and to thus determine which parameters lead to full penetration welding. This may be useful as reference at least and might result in efficiently approaching an ideal value as a gradually deeper welding without full penetration welding. Alternatively or additionally, micrographs of the weld seam created may be generated.

By using the method according to the invention, a computing-intensive welding penetration depth control is not necessary anymore. Thus, it is not necessary anymore to use expensive calculation units, which potentially require graphics boards which cannot be integrated directly into the machining device due to their size. In addition, the data for calculating the welding penetration depth control does not have to be transmitted from the machining device to the calculation unit and from the calculation unit to the machining device anymore. A complex and calculation-intensive online calculation of the welding penetration depth control is thus not necessary anymore.

By using the method according to the invention, a high degree of quality can be achieved. Even if the equipment for ascertaining an inline welding penetration depth is available, by subsequently ascertaining locations that need remachining and the targeted remachining of those, a welding result that might not be achieved by ascertaining online welding penetration depth alone can be achieved. In particular the fact that if the online welding penetration depth is ascertained, future readings are not available yet, which, however, might affect a quality of ascertaining, can be attributed for. However, the temporal division of welding and recognizing the welding penetration depth makes it possible to also take those readings into account and consider them for notifications and fits, for example. In addition, excessive control, particularly during setting times of the welding penetration depth, can be prevented by this.

In principle, a computing-intensive welding penetration depth control would also not be necessary. Thus, it would not be necessary anymore to use expensive calculation units, which potentially have to comprise expensive graphics boards. In addition, the data for calculating the welding penetration depth control does not have to be transmitted from the machining device to the calculation unit and from the calculation unit to the machining device in real time anymore. A complex and calculation-intensive online calculation of the welding penetration depth control is thus not absolutely necessary anymore.

By using the method according to the invention, it is rather possible to determine the remachining location directly and/or offline on an evaluation unit, which can be integrated into the machining device. As a result, the production costs incurred when creating the weld seams may be lowered significantly at sufficient and/or consistent quality of the weld seams.

### LIST OF REFERENCE SIGNS

S1 creating the weld seam

S2 scanning the weld seam

S3, S3‘ determining a remachining location

S4 reworking the weld seam at least at one remachining location

S5 determining a context at the remachining location

S6 adapting the laser performance

S10 creating a calibration weld seam

S11 ascertaining a property of the calibration weld seam

S12 determining a context based on the calibration weld seam

S13 adapting the laser performance in accordance with the context based on the calibration weld seam

10 weld seam

20 workpiece

30 machining beam

40 sample beam

60 machining apparatus

65 machining beam source

70 sample apparatus

80 evaluation apparatus

100 machining device

110 focusing lens

120 machining scanner

130 mirror

140 sample scanner

150 sample beam collimation lens

160 machining beam collimation lens

170 coherence tomograph

What is claimed is:

1. A method for creating a weld seam on a workpiece with a high-energy machining beam, comprising the following steps:
creating the weld seam on the workpiece by means of the machining beam;
scanning the weld seam by means of a sample beam of an optical coherence tomograph;
determining at least one remachining location at which a welding penetration depth is below a target welding penetration depth and/or at which a pore size, a target pore size and/or a porosity exceeds a target porosity; and
reworking the weld seam at least at one remachining location by means of the machining beam.

2. The method of claim 1,
wherein the reworking of the weld seam is selectively carried out at the remachining location and/or at the remachining locations.

3. The method of claim 1,
wherein the machining beam may be created by a machining apparatus and the sample beam may be created by a sample apparatus, which are part of a machining device, and
wherein determining the remachining location is carried out in an evaluation apparatus disposed in the machining device.

4. The method of claim 1,
wherein the remachining location is being determined while the weld seam is being scanned and/or after the weld seam is being scanned.

5. The method of claim 1,
wherein determining the remachining location is based on a plurality of measuring points and/or on a single measuring point, which are or is identified when the sample beam scans the weld seam.

6. The method of claim 1,
further comprising the following steps:
determining a context at the remachining location between a property of the weld seam at the remachining location, a desired property of the weld seam and a laser performance, with which the machining beam, by means of which the weld seam has been generated at the remachining location, has been created; and
adapting the laser performance, in particular at the remachining location, in accordance with the context;
wherein determining the context at the remachining location and adapting the laser performance may take place before reworking the weld seam at the remachining location and after determining the remachining location.

7. The method of claim 1,
further comprising the following steps:
re-determining at least one remachining location at which a welding penetration depth is below a target welding penetration depth and/or at which a pore size, a target pore size and/or a porosity exceeds a target porosity;
wherein re-determining of at least one remachining location is carried out after reworking the weld seam at the at least one remachining location.

8. The method of claim 1,
further comprising the following steps:
creating a calibration weld seam by means of a machining beam;
ascertaining a characteristic of the calibration weld seam by means of a sample beam;
wherein creating the calibration weld seam and ascertaining the characteristic of the calibration weld seam are carried out before the weld seam is created.

9. The method of claim 8,
further comprising the following steps:
determining a context of the calibration weld seam between the characteristic of the calibration weld seam, a desired characteristic of the weld seam and a laser performance, with which the machining beam, by means of which the calibration weld seam has been generated, has been created;
adapting the laser performance in accordance with the context of the calibration weld seam;
wherein determining the context on the basis of the calibration weld seam and adapting the laser performance in accordance with the context on the basis of the calibration weld seam are carried out before the weld seam is created.

10. The method of claim 6,
wherein the characteristic of a welding penetration depth is a number of pores and/or the pore size, and/or
wherein the desired characteristic is a target welding penetration depth, a target number of spores and/or a target pore size.

11. A machining device for creating a weld seam on a workpiece by means of a machining beam configured to carry out a method according to any one of the preceding claims, comprising:
a machining apparatus comprising a machining beam source configured to create the machining beam;a sample apparatus configured to scan the weld seam with a sample beam;a focusing apparatus configured to project and/or focus the machining beam onto the workpiece; andan evaluation apparatus configured to determine at least one remachining location on the weld seam on the basis of scanning by means of the sample apparatus.

12. The machining device of claim 11,
wherein the sample apparatus comprises an optical coherence tomograph configured to generate the sample beam and a reference beam;
the optical coherence tomograph, comprising:
a sample arm in which the sample beam is optically guidable;
a reference arm in which the reference beam is optically guidable;
a sample unit configured to perform optical coherence tomography measurements by causing the sample beam (and the reference beam to interfere to generate measurement data.
